(19) United States
(12) Patent Application Publication
(10) Pub. No.: US 2010/0008630 A1
(43) Pub. Date: Jan. 14, 2010

(54) Locking Mechanism for Optical Tranceivers

(75) Inventors: Thomas R. Marrapode, Naperville, IL (US); Maurice X. Sun, Naperville, IL (US); Yuriy Belenkiy, NIles, IL (US)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 12/084,394

(22) PCT Filed: Nov. 1, 2006
(86) PCT No.: PCT/US2006/042592

§ 371 Date: Aug. 24, 2009

(30) Foreign Application Priority Data
Nov. 1, 2005 (US) 60/732337

(51) Int. Cl. G02B 6/36; G02B 6/38

(52) U.S. Cl. 385/78; 385/139

(57) ABSTRACT

A locking mechanism for connecting an optical connector to the TOSA or ROSA connector of an optical transceiver having no cover. The locking mechanism includes a connector plug equipped with an interface apparatus having a clip installed to the plug, a locking mechanism that keeps the clip in place and a spring mechanism that provides force for maintaining physical contact between the ferrule end face and the optical plane of the TOSA and ROSA.

### FIELD OF THE INVENTION

The present invention relates generally to connectors for use with an optical transceiver and, more particularly, to an optical sub-assembly connector for use with an optical transceiver lacking an outside housing.

### BACKGROUND OF THE INVENTION

Optical link modules are widely used in data links and in optical communication systems such as an optical LAN, which uses light as an information transmitting means. As is shown in FIG. 1 and FIG. 2, a conventional optical link module 100 comprises a housing 102, and a printed circuit board (PCB) 106 disposed on the bottom surface 104 of the housing 102. A transmitting optical sub-assembly (TOSA) 107, and a receiving optical sub-assembly (ROSA) 108, electronic parts 110 are mounted on the board.

In a typical optical transceiver, the TOSA 107 and the ROSA 106 are usually soldered onto the PCB then enveloped with the outside housing 102. The housing 102 is configured to provide mechanical mountings for the PCB, the TOSA and the ROSA. The outside housing further provides connector interface features that receive a standard optical connector such as an LC connector 114. Other connector types such as SC, ST, FC also may be used.

Unfortunately, when the optical module is used in a space saving configuration where the optical transceiver 100 does not include the outside housing 102, standard LC, SC, ST, FC and LT type connectors mentioned above cannot be used because there is no locking mechanism to keep the connectors attached to the TOSA 108 and ROSA 107.

### DESCRIPTION OF THE DRAWINGS

FIG. 1 illustrates an optical transceiver having an outside housing and attached LC connector;

FIG. 2 illustrates the optical transceiver of FIG. 1 without the outside housing;

FIG. 3 illustrates the optical transceiver if FIG. 1 without the outside housing and the LC connector;

FIG. 4 illustrates a known LC connector and ferrule;

FIG. 5 illustrates an LC ferrule;

FIG. 6 illustrates a clip used for securing an LC plug based ferrule to a TOSA or ROSA in accordance with an embodiment of the invention;

FIG. 7 is a schematic view of the metal clip of FIG. 6;

FIG. 8 illustrates an ST ferrule and shroud connected to a TOSA or ROSA in accordance with another embodiment of the invention;

FIG. 9 illustrates the shroud of FIG. 8;

FIG. 10 illustrates connection of the ST ferrule to the TOSA or ROSA;

FIG. 11 is a cross-sectional view of the shroud of FIG. 9; and

FIG. 12 illustrates a shroud used for securing an LC connector based ferrule to a TOSA or ROSA in accordance with an embodiment of the invention.

### DETAILED DESCRIPTION

In order to overcome the disadvantages of the prior art and to provide a means for connecting an optical connector to the TOSA or ROSA connector of an optical transceiver having no cover, there is provided a connector plug equipped with an interface apparatus that includes a clip installed to the plug, a locking mechanism that keeps the clip in place and a spring mechanism that provides force for physical contact between the ferrule end face and the optical plane of the TOSA and ROSA.

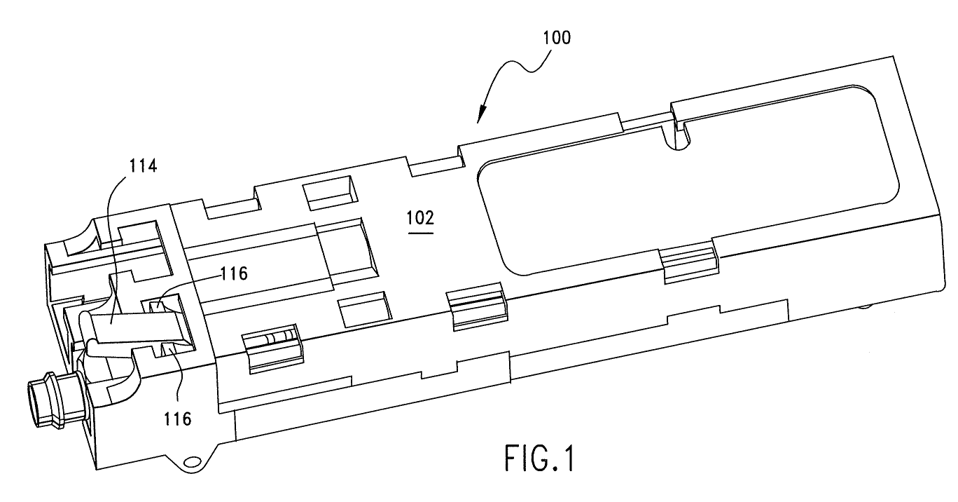

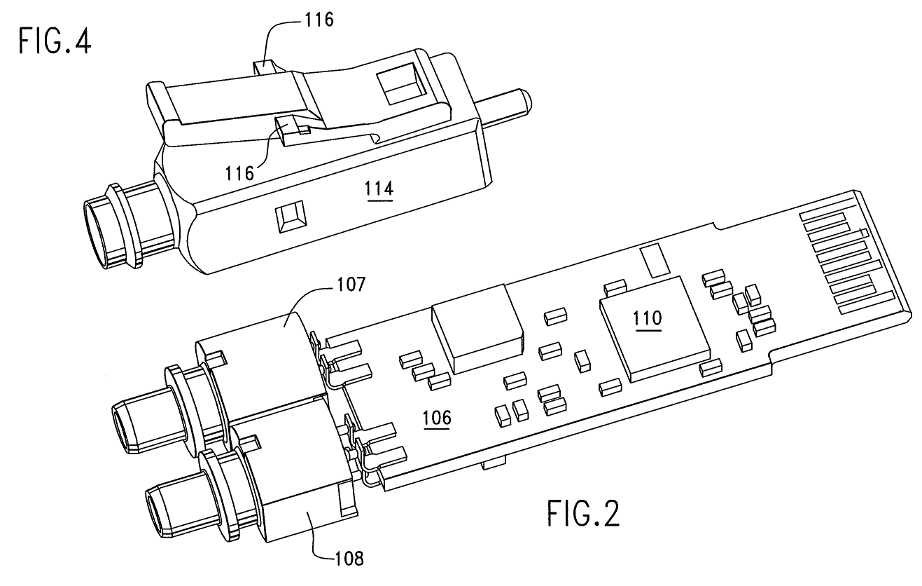

FIG. 1 shows a known optical transceiver 100. The transceiver 100 includes an outer housing 102 that is formed with a latching system for receiving a complementary latch from an optical connector latch, such as that from an LC connector 114. The LC connector 114 itself is in contact with and engages the TOSA 108 and/or ROSA 107 of the optical transceiver 100. Latching shoulders 116 are provided for engaging the housing 102 of the optical module 100. As shown in FIG. 2, the housing 102, when removed from the optical transceiver 100, is then no longer able to provide a latching system for the connector.

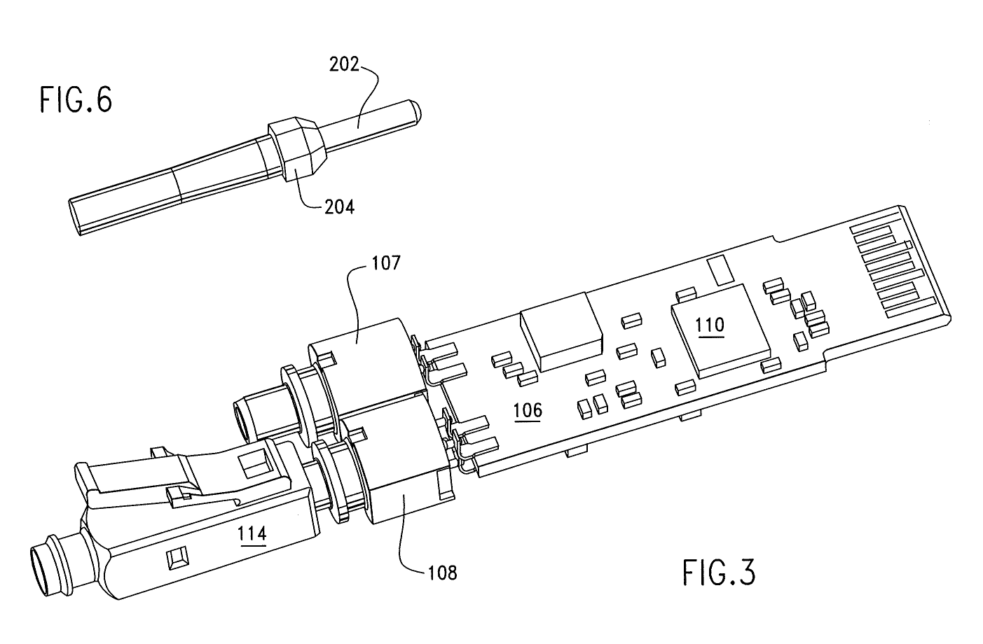

As shown in FIG. 3, without some type of latching system, the optical connector 114 may easily be dislodged from the TOSA/ROSA 107, 108. This is because the TOSA/ROSA 107, 108 modules themselves do not have any engaging means for capturing and holding the optical connector 114. In particular, FIG. 4 shows a standard LC connector 114 where it can be seen that, like the TOSA/ROSA modules 107, 108, there is no latching system on the optical connector 114 for engaging the TOSA/ROSA 107, 108 of the transceiver. Clearly the shoulders 116 of the LC connector 114 are of no use when the housing is not present on the optical module.

FIG. 5 shows an exemplary locking mechanism 200 for use with an LC plug in accordance with a first aspect of the present invention. A particular advantage of the instant locking system is that standard connector types are easily adapted to be used in instances where a low-profile or a relatively smaller form factor optical module is required.

The locking mechanism 200 incorporates an LC ferrule 202 (FIG. 6), but does not require the connector portion or outside housing of the LC connector. In particular, the locking mechanism 200 includes an LC ferrule 202 having a forward stop ring 204, a spring 210 for providing a biasing force, a clip 208 configured to engage a TOSA/ROSA module 107, 108 module and a locking device 206 to keep the clip 208 and the spring 210 in place.

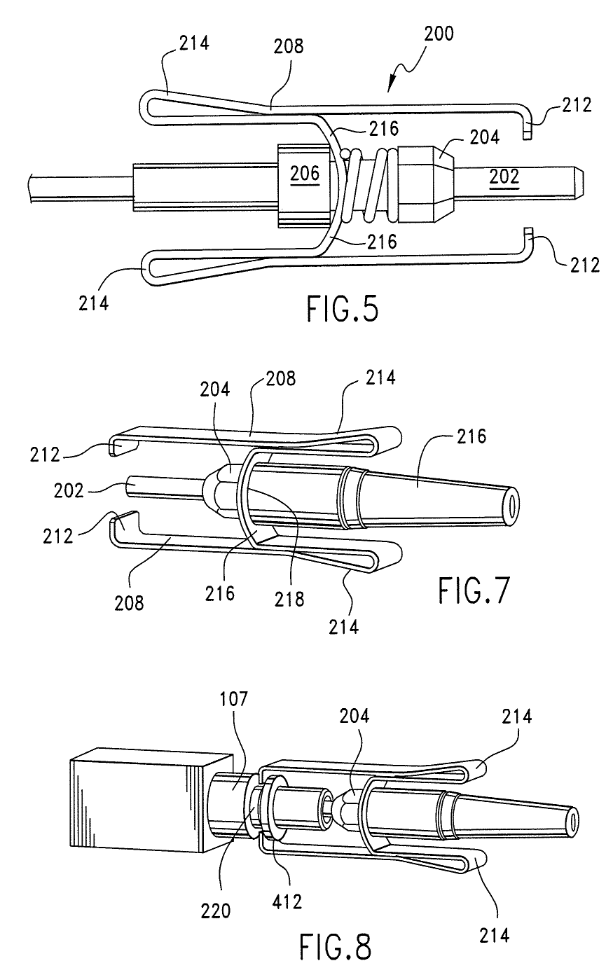

As shown more clearly in FIG. 7, the clip 208, which may be made of metal, plastic, or other material, includes a pair of extending arms 208 that terminate to a pair of L-shaped fingers 212 on a first end. The arms 208 are separated by a flexible bridge 216 that is located between each of the arms 208. The ends of the L-shaped fingers 212 may be configured with a slightly rounded profile to more closely match the rounded profile of the TOSA/ROSA module 107, 108. This has the advantage of adding stability because of the somewhat larger surface area that the fingers are able to engage on the TOSA/ROSA module. In addition, in the exemplary embodiment, for ease of manufacturing, the clip 208 is formed from a single piece of material that is bent or molded into the required shape. It is to be noted that the clip may be formed from multiple pieces as well with equal effect.

The other end of the arms terminates to a pair of finger levers 214. The finger levers are formed at a lightly upwardly extending angle to enable ease of gripping and pressing. In addition, a dual layer of the material is looped underneath the finger lever 214. An advantage of this configuration is that force placed on the finger levers 214 does not cause the levers to bend downward where the force itself is applied. Instead, the force moves towards the junction of the bridge 216 and the finger lever 214. Therefore, when the finger levers 214 are pressed in an inward direction, the opening of the arms 208 widens. When released, the arms 208 return to their normal position. The bridge portion 216 also includes an aperture 218 through which the ferrule 202 is inserted. A molded boot 218 is optionally provided to hide portions of the ferrule 202 and the locking device 206 or to keep the locking device 206 in its place.

It should be noted that the thickness and width of the materials used in manufacturing of the clip 208 may be varied depending on the amount of force desired to operate the clip. For example, in those applications where repeated installation and removal is needed, thinner materials or a relatively narrower clip may be more desirable to make such repeated installations and removals easier. Conversely, if removal is rare, the manufacturer may require a thicker or wider clip to prevent the clip from accidentally being pulled off or removed.

Similarly, the spring 210 may be chosen from a variety of springs having different spring constants. Depending on the particular application, the biasing force may be greater or less as needed.

FIG. 8 illustrates the locking mechanism 200 engaging a TOSA/ROSA 107, 108. As shown, when in a connected configuration, the L-shaped fingers 212 engage the circular recess 220 of the TOSA/ROSA 107, 108. The spring 210 (FIG. 5), which sits between the LC ferrule ring 204 and the bridge portion 216 of the metal clip 208, provides a forward bias to the ferrule 202 such that the end face of the ferrule 202 and the optical plane of the TOSA/ROSA 107, 108 are securely maintained in an engaged position. The locking device 206 (FIG. 5) provides a stop against which the spring 210 and bridge 216 rest.

In operation, the user installing the device squeezes the finger levers 214. This is in turn causes the arms 208 to expand slightly on the end having fingers 212. The clip 200 is then placed into position over the top of the TOSA/ROSA block 107, 108. The user then overcomes the bias provided by the spring 210 by pushing the clip forward such that the L-shaped fingers 212 are placed into position around the TOSA/ROSA collar 220 and the levers 214 are then released. Upon release, the fingers 212 engage the collar 220, which enables the clip 200 to stay in place. In addition, the spring 210 provides forward biasing of the LC ferrule such that the end face of the ferrule 202 and the optical plane of the TOSA/ROSA are securely maintained in their engaged position.

FIG. 12 illustrates a slightly different physical embodiment of the LC based locking mechanism. As shown, the locking mechanism 400 is used in an LC connector based configuration. In this exemplary embodiment, a shroud 401, made of plastic or metal, is placed over an LC connector 418. The shroud 401 includes apertures 403 for engaging shoulders (not shown) of the LC connector 418 to hold the shroud 401 securely in place over the LC connector 418.

The shroud 401, which may be made of metal, plastic, or other material, includes a pair of extending arms 408 that terminate to a pair of L-shaped fingers 412 on a first end. The other end of the arms terminates to a pair of finger levers 414. The levers include serrated or raised relief edges for improving grip.

The arms 408 are separated from the body of the shroud by bridges 416 that are located between each of the arms 408. When the finger levers 414 are pressed in an inward direction, the opening of the arms 408 widens. When released, the arms 408 return to their normal position. Operation of the LC connector based locking mechanism is substantially similar to the LC plug based locking mechanism described above.

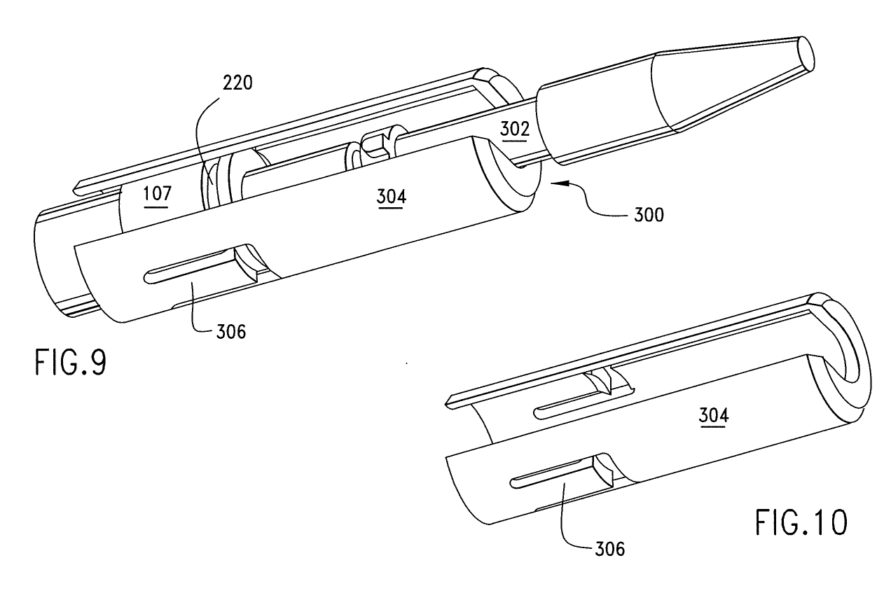

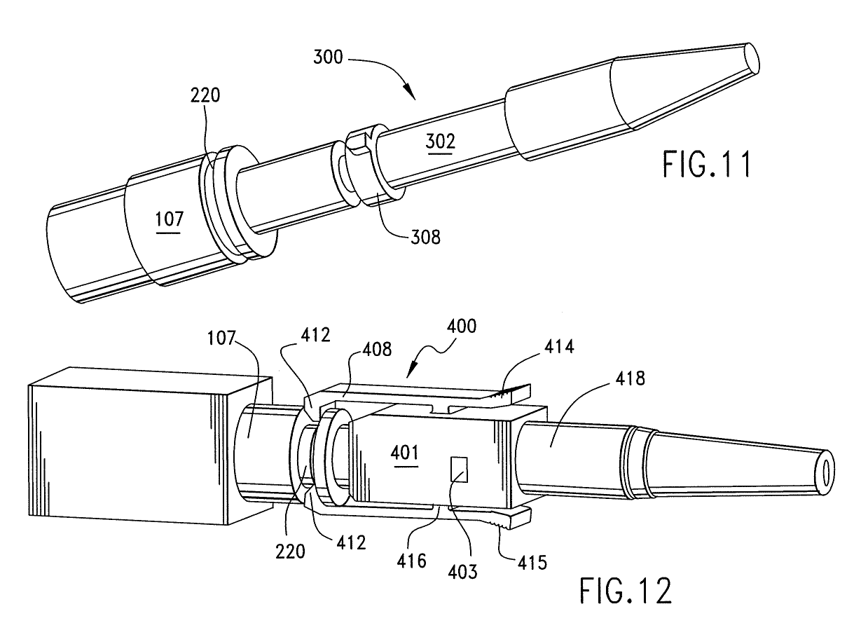

FIGS. 9-11 show an alternate embodiment of the invention using, by way of example only, an ST connector 300 and ferrule 302. This particular embodiment includes a shroud 304 or outer housing that encompasses the ferrule 302. The shroud 304 includes a pair of anus 306 configured to engage the collar 220 of the TOSA/ROSA 107. In addition, a spring (not shown) is provided inside the shroud 304 where it sits between the outer forward portion of the shroud 304 and the collar of the ST plug when the ST plug is inserted into the shroud.

In operation, much like the LC embodiment of the invention, the user installing the device places the shrouded connector into position over the top of the TOSA/ROSA block. The user then overcomes the spring bias by pushing the shroud forward such that the arms are placed into position around the TOSA/ROSA collar. The spring provides forward biasing of the ST ferrule such that the end face of the ferrule and the optical plane of the TOSA/ROSA are securely maintained in their engaged position.

What is claimed is:

1. A locking mechanism for an optical transceiver without a housing and having an optical plug assembly, the locking mechanism comprising;
a clip installed on the optical plug assembly of the optical transceiver, the clip configured to receive and hold a ferrule;
a locking mechanism configured to retain the clip in place on the optical plug assembly; and
a spring mechanism for forcing physical contact between an end face of the ferrule and an optical plane of the optical plug assembly.

2. The optical plug assembly of claim 1, further comprising a ceramic ferrule and overmolded plastic.

3. The optical plug assembly of claim 1, wherein the clip is configured as a shroud for receiving and securing a ferrule, the shroud further configured to force physical contact between an end face of the ferrule and an optical plane of the optical plug assembly.

4. The optical plug assembly of claim 1, wherein the clip is made of metal.

5. A locking mechanism for an optical transceiver without a housing and having an optical plug assembly, the locking mechanism comprising;
a shroud installed over the optical connector assembly of the optical transceiver, the shroud configured to receive and hold a connector;
a locking mechanism configured to retain the shroud in place on the optical plug assembly; and
a spring mechanism for forcing physical contact between an end face of the ferrule and an optical plane of the optical plug assembly.

6. The optical plug assembly of claim 1, further comprising a ceramic ferrule and overmolded plastic.

7. The optical plug assembly of claim 1, wherein the shroud is made of plastic.
